(19) United States
(12) Patent Application Publication
(10) Pub. No.: US 2006/0150453 A1
(43) Pub. Date: Jul. 13, 2006

(54) Electronic illuminated address sign for homes and businesses

(76) Inventors: Victor George Martin, Garland, TX (US); Mauline Joy Martin, Garland, TX (US)

Correspondence Address: VICTOR G. MARTIN, 513 Willowcrest Drive, Garland, TX, 75040, US

(21) Appl. No.: 11/170,238

(22) Filed: Jan. 3, 2005

(51) Int. Cl. G09F 13/22

(52) U.S. Cl. 40/544

(57) ABSTRACT

An Electronic Illuminated Address Sign (EIAS) for homes and businesses is provided for displaying alphanumeric address information with automatic power-on for night viewing. The Electronic Illuminated Address Sign incorporates features to enhance daytime viewing and means to daisy-chain several characters together to form an address or slogan. The Electronic Illuminated Address Sign further incorporates means to display characters with many different colors. In an emergency, the Electronic Illuminated Address Sign incorporates means to flash the characters at a predetermined rate to draw attention to the Sign, when the user activates an external switch.

### BACKGROUND OF THE INVENTION

Recent advances in the field of semiconductor technology and Light Emitting Diodes (LED) have made it possible to produce a variety of electronic devices which have not been technically or economically feasible for use by consumers in the past. In particular, electronic solid state products such as Liquid Crystal Displays (LCD), Incandescent Light Displays, Electroluminescent Displays (ELD), Back-lighted Displays and Light Emitting Diode (LED) Displays have become increasingly sophisticated with advances in technology. Thus, a need has arisen for an Electronic Illuminated Address Sign that illuminates automatically at night and displays alphanumeric address information readable day or night.

An Electronic Illuminated Address Sign is desired for displaying address information at night to facilitate locating said structures by emergency personnel such as fire, police, and medical. In addition, evening and night deliveries are made easy with an Electronic Illuminated Address Sign.

### SUMMARY OF THE INVENTION

The present invention is a modular Electronic Illuminated Address Sign having a Light Emitting Diode (LED) alphanumeric display system. The user assembles the Electronic Illuminated Address Sign by selecting, arranging and installing the alphanumeric characters to be displayed. The Electronic Illuminated Address Sign includes a Pulse Width Modulator (PWM) Timer which generates a refresh clock to the LED display(s) and an Optical Sensor for automatically applying power to the display at night. The Electronic Illuminated Address Sign also includes means to display characters in many different colors. The Electronic Illuminated Address Sign operates from a rechargeable battery or an AC to DC Adapter.

### BRIEF DESCRIPTION OF THE DRAWINGS

For a more complete understanding of the present invention and for further advantages thereof, reference is now made to the following detailed description of the Preferred Embodiment taken in conjunction with the accompanying drawings, in which:

FIG. 1 is a pictorial representation of one embodiment of the Electronic Illuminated Address Sign according to the present invention.

FIG. 2 is a block diagram of the electronic components of the present invention.

### DETAILED DESCRIPTION OF THE PREFERRED EMBODIMENT

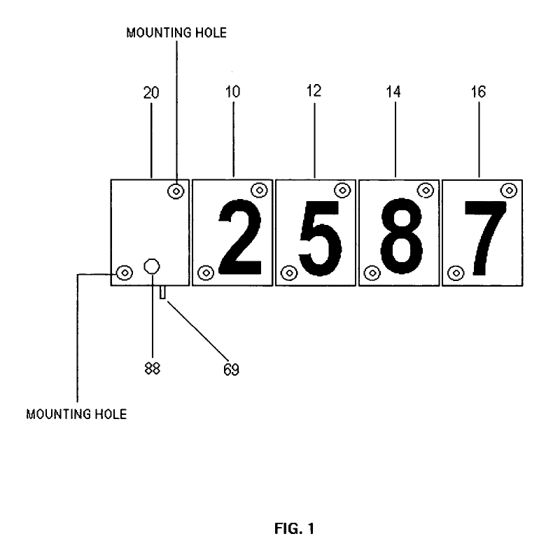

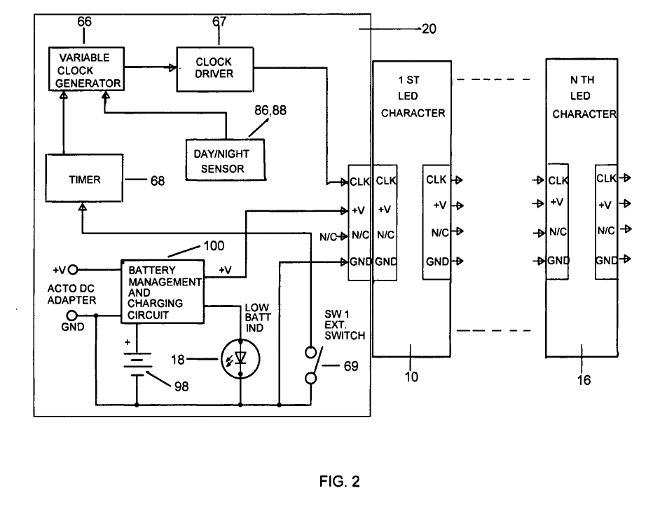

Referring to FIG. 1, there is depicted in pictorial illustration one embodiment of an Electronic Illuminated Address Sign according to the present invention. Electronic Illuminated Address Sign Controller (20) includes an Optical Sensor (88) and Switch (69) for enabling the display to flash at a predetermined rate and Alphanumeric Display Characters (10, 12, 14, and 16) for visually presenting data. In one embodiment, Electronic Illuminated Sign Controller (20) is connected to Four LED characters (10, 12, 14, 16) daisy-chained together as shown in FIG. 1. It will be apparent from Electronic Illuminated Address Sign (20, 10, 12, 14 and 16) as shown in FIG. 1, that various alphanumerical data may be displayed. Referring now to FIG. 2, there is shown a schematic representation in block diagram form of one embodiment of Electronic Illuminated Address Sign Controller (20). Variable duty cycle Clock Generator (66) sets the display

(10, 12, 14, 16) scan frequency. Optical Sensor (88) activates switch (86) at night applying power to displays (10, 12, 14, 16) illuminating the alphanumeric characters. Referring again to FIG. 2, in accordance with a particular feature of the present invention the individual alphanumeric characters (10, 12, 14, 16) are assembled or daisy-chained together to form the desired address or slogan. Ancillary circuits include an external AC to DC Adapter, power supply (98) and an associated logic circuit (100) for detecting a low battery condition and charging battery (98). As shown in FIG. 2, a low battery condition may further serve to activate LED indicator (18) to alert the user. External switch (69) is provided to enable Timer (68) output signal, causing variable clock generator (66) output signal to flash the characters at a predetermined rate drawing attention to the display.

It is apparent that the present invention is one well adapted to attain all the features herein above set forth together with other features which will become obvious from the description of the apparatus itself. It will be understood that certain combinations and sub-combinations are of utility and may be obtained without reference to other features and sub-combinations. It is intended that the present invention encompass changes and modifications to the foregoing preferred embodiment as fall within the scope of the appended claims.

1. An Electronic Illuminated Address Sign comprising:
a control unit with optical sensor for determining day or night;
and display means connected to said control unit via a daisy-chain connection system.

2. An Electronic Illuminated Address Sign wherein each character is illuminated independently and incorporate means to stack or daisy-chain characters together to form an address or slogan.

3. An Electronic Illuminated Address Sign comprising a variable pulse width clock generator for providing optimum character brightness and reducing power consumption when additional character is added to the display chain.

4. The Electronic Illuminated Address Sign of claim 2, wherein each character incorporate means to ensure readability in daylight without power.

5. The Electronic Illuminated Address Sign of claim 1, further comprising means to illuminate a LED when battery power is low.

6. The Electronic Illuminated Address Sign of claim 1, comprising means for displaying alphanumeric data, the improvement comprising means for selecting, arranging and daisy-chaining alphanumeric characters together to form addresses or slogans.

7. The Electronic Illuminated Address Sign of claim 2, wherein each character or character pixel element can be a different color.

8. The Electronic Illuminated Address Sign of claim 3, wherein the characters flash at a predetermined rate to signal an emergency, when the user activates an external switch.
